(19) United States
(12) Patent Application Publication
(10) Pub. No.: US 2021/0089036 A1
(43) Pub. Date: Mar. 25, 2021

(54) METHOD AND DEVICE FOR CALCULATING A TRAJECTORY OF A VEHICLE

(71) Applicant: Robert Bosch GmbH, Stuttgart (DE)

(72) Inventor: Holger Andreas Banzhaf, Laichingen (DE)

(21) Appl. No.: 16/629,867

(22) PCT Filed: Jun. 6, 2018
(86) PCT No.: PCT/EP2018/064862

§ 371 Date: Jan. 9, 2020

(30) Foreign Application Priority Data
Jul. 13, 2017 (DE) 102017212044.4

(51) Int. Cl. G05D 1/02

(52) U.S. Cl. CPC G05D 1/0212; B62D 15/027

(57) ABSTRACT

A method and a device for calculating a trajectory of a vehicle. In this context, a starting position and a target position of the vehicle are defined; a number of possible trajectories, which precisely interconnect the starting position and the target position, are generated, for each possible trajectory, different path elements being interlinked in different ways to interconnect the starting position and the target position of the vehicle, the path elements being interlinked in such a manner, that a possible trajectory may only have a discontinuous curvature characteristic at a node between two path elements, if the possible trajectory traces a change of direction of the vehicle at the node; and a trajectory is selected from the possible trajectories on the basis of a characteristic of the possible trajectories.

### FIELD OF THE INVENTION

The present invention relates to a method and a device for calculating a trajectory of a vehicle.

### BACKGROUND INFORMATION

The maneuvering of vehicles in tight settings plays an important role, above all, in parking. First of all, the difficulty is to generate a collision-free path having as few changes of direction as possible, as short a path length as possible, and a low change in curvature over its course.

In the near future, automated vehicles will be parked in a highly dense manner, that is, vehicles will be parked more closely and possibly parked in such a manner, that displacing operations will be necessary, in order to move another vehicle out of a parking space. From this, highly non-convex state spaces are formed, in which a path must be found for maneuvering a vehicle.

A possible approach for solving this path-planning problem includes sampling-based movement planners, for example, rapidly-exploring, random trees. In this context, two configurations in the state space are randomly sampled, and these are connected exactly to a so-called steering/extended function. If the connected path is collision-free, it is added to a tree (graph). Due to this, the state space does not have to be discretized, and the optimum solution is converged to probabilistically, if one exists.

The difficulty for vehicles having a minimal turning radius is to find a steering function for connecting two configurations exactly and simultaneously optimizing a given cost criterion (e.g., length, curvature, number of changes in direction, . . . ). Of course, vehicles, which are able to turn on the spot (keyword: omnisteer) are excepted from this.

In this case, Reeds-Shepp (RS) steering and continuous-curvature (CC) steering belong to the related art.

The advantage of Reeds-Shepp steering (RS steering) is that the shortest path between two points is found. The disadvantage is that the path found is made up exclusively of curves and straight lines. The discontinuous characteristic of the curvature results in one's having to stop during the trip, in order to set the new curvature, and only then being able to travel on. Thus, not practical in reality.

Continuous curvature steering (CC steering) addresses this problem by allowing only a continuous characteristic of the curvature. To that end, clothoids are also used between straight lines and circles, in order to render the change in curvature continuous. In this instance, the problem is that the clothoids make the paths longer, and that maneuvering in very tight settings becomes difficult to impossible.

To that end, FIG. 7 shows a representation of a trajectory 3 computed with the aid of Reeds-Shepp steering; trajectory 3 connecting a starting position to a target position 2. In addition, FIG. 8 shows a representation of a trajectory 3, which is computed with the aid of continuous-curvature steering and connects a starting position 1 to a target position 2, as well.

### SUMMARY OF THE INVENTION

The method of the present invention for computing a trajectory of a vehicle includes defining a starting position and a target position of the vehicle; generating a number of possible trajectories, for each possible trajectory, different path elements being interlinked in different ways in order to interconnect the starting position and the target position of the vehicle, the path elements being interlinked in such a manner, that at a node between two path elements, a possible trajectory may only have a discontinuous curvature characteristic, if the possible trajectory traces a change of direction of the vehicle at the node; and selecting a trajectory from the possible trajectories on the basis of a characteristic of the possible trajectories.

The device of the present invention for calculating a trajectory of a vehicle includes a processing unit, which is configured to define a starting position and a target position of the vehicle; to generate a number of possible trajectories, for each possible trajectory, different path elements being interlinked in different ways, in order to interconnect the starting position and the target position of the vehicle, the path elements being interlinked in such a manner, that at a node between two path elements, a possible trajectory may only have a discontinuous curvature characteristic, if the possible trajectory traces a change of direction of the vehicle at the node; and to select a trajectory from the possible trajectories on the basis of a characteristic of the possible trajectories.

Consequently, a trajectory of a vehicle from a starting position to a target position is calculated. The method and the device are suitable for calculating a trajectory of a vehicle, having limited curvature/minimal turning radius. In this context, the trajectory is a path, which traces a motion of a vehicle, having a minimal curvature/turning radius, and therefore describes the steering movements necessary for this, as well. The trajectory at a maximum steering angle may be described mathematically by a continuous curve. In this context, the trajectory of the midpoint of the rear axle or of the center of mass is not necessarily identical to the path, which is traveled by a wheel of a vehicle. Thus, a movement of a point of the vehicle during a motion of the vehicle is traced by the trajectory. A necessary steering movement may be deduced directly from such a trajectory. If, for example, the trajectory is represented mathematically as a function, then the curvature, and thus, the steering movement, as well, may be ascertained, for example, with the aid of a derivative of the function.

The defining of the starting position and the target position is the specifying of two positions of the vehicle. In this context, the starting position describes an orientation and a position of the vehicle with respect to a reference system. In this instance, the target position describes an orientation and a position of the vehicle with respect to the reference system. The defining of the starting position and the target position takes place, in particular, with the aid of a data set, which is provided as a basis for computing the trajectory. Such a data set is provided, for example, by a driving assistance system.

During the generating of a number of possible trajectories, a plurality of individual trajectories are generated; each of the possible trajectories interconnecting the starting position and the target position of the vehicle. Thus, different sequences of steering movements are ascertained, which are to be carried out by the vehicle, in order to be moved from the starting position to the target position. In this context, the vehicle is moved in such a manner, that it arrives at the target position in a desired orientation.

In this context, a path element is an element, which mathematically describes a path of a portion of the trajectory. Thus, for example, a path element defines a curve shape. In this context, a predefined set of path elements is accessed, in order to link them to each other. In the generating of a possible trajectory, path elements of the same or of different type are put together, in order to provide a connection between the starting position and the target position, which is to be followed by the vehicle in order to get from the starting position to the target position. In this context, the path elements may be adapted, in order to fit into the trajectory to be generated. Thus, for example, a path element, which describes a straight line, may be adapted in such a manner, that the straight line has a desired length. In a further example, a path element, which describes a curved path, may be adapted in such a manner, that the curved path has a desired length; a curve angle between a curve entrance and a curve exit being correspondingly changed, but the basic shape of the curve being retained. In this context, a path element may determine a moving direction, as well, in which the vehicle is to move while following the trajectory in the region of the respective path element.

The different path elements are interlinked in different ways, in order to generate the possible trajectories. In this instance, a possible trajectory may include one or more of the different path elements. Different, possible trajectories may include different or identical path elements. If two trajectories include the same path elements, then these are positioned in a different order.

In this context, the linking of the different path elements is based on at least one fundamental rule: The path elements are to be interlinked in such a manner, that at a transition between two path elements, a possible trajectory only has a discontinuous curvature characteristic, if the trajectory simultaneously describes a change of direction of the vehicle at the transition. This means that possible trajectories, in which the following occur, are discarded or not even generated: two path elements, which trace an identical moving direction, and at whose node a change of direction is consequently not necessary, border on each other; and in the path elements, a discontinuous curvature characteristic is simultaneously present at the spot, at which they border on each other. In other words, this means that between two path elements, each possible trajectory may only have a sharp bend, if a change of direction of the vehicle simultaneously takes place at this point of the trajectory. A sharp bend is a location on a possible trajectory, at which the vehicle must turn the wheels while standing, in order to follow the trajectory.

A discontinuous curvature characteristic means that a derivative of a trajectory represented as a curve is not continuous, that is, has a sudden change, at the connecting point of two consecutive path elements.

Thus, a method and a device for computing a new steering function is provided, which lives between the two worlds of RS steering and CC steering. Discontinuous changes in curvature are only allowed, if the vehicle changes direction. To that end, the maneuverability is increased while simultaneously ensuring that the paths traced by the trajectory may be followed directly.

During forward or reverse travel, only continuous curvature characteristics are allowed, which is rendered possible, in particular, by the use of circles, straight lines and clothoids as path elements; clothoids constituting, in particular, an option of a continuous-curvature connection between a circle and a straight line. In the case of a change of direction of the vehicle, it is allowable for the curvature to be changed, e.g., by turning the steering wheel completely to the left after having turned the steering wheel completely to the right, and consequently, in this case, for the curvature to have a noncontinuous characteristic. This steering function is referred to as hybrid-curvature steering (HC-steering). It is configured for human maneuvering in tight settings, in which we humans turn the steering wheel at a dead stop, as well, in order to, e.g., come into a parking space more effectively.

Trajectories generated according to the present invention have the advantage that they may be followed immediately. HC steering increases the maneuverability of the vehicle in comparison with CC steering. A computing time for connecting two configurations, in this case, a starting position and a target position, lies in the microsecond range and is, therefore, very short.

The further embodiments show further refinements of the present invention.

The number of possible trajectories may be generated in such a manner, that the different path elements are combined with each other in different ways. Consequently, it is ensured that various, possible trajectories differ from each other.

In this context, it is advantageous when each of the possible trajectories is a predefined combination of the different path elements. Thus, in particular, a number of sets of path elements is provided; each set including a sequence of certain path elements and, in particular, instructions for changing direction between the path elements, as well. Such a set of path elements is also referred to as a family. The sets of path elements may include a number of path elements different from each other. Therefore, a quantity of possible trajectories, which may be generated, in principle, from the path elements, is limited, since not all of the theoretically possible combinations of path elements must be considered. Thus, the possible trajectories are generated, in particular, in such a manner, that the path elements are interlinked in accordance with the order defined in the sets.

The different path elements may include a curve element, and during the generation of the number of possible trajectories, the curve element is selected from one of the following: an RS curve element, which describes a curve having a constant curve radius; an HC curve element, which is a combination of a curve having a constant radius and a curve having a radius increasing or decreasing over a stretch of path, with the characteristic of a minimum radius on the one side and an infinitely large radius on the other side; and a CC-curve element, which is a combination of a curve having a constant radius and, in front of it or in back of it, in each instance, a curve having a radius that increases or decreases over a stretch of path. The RS curve element is a Reeds-Shepp curve element. The CC curve element is a continuous-curvature curve element. In the case of the RS curve element and/or the CC curve element, the curve having the radius increasing or decreasing over a stretch of path is, in particular, a curve having a radius linearly increasing or decreasing over a stretch of path and, in this case, is also referred to as a clothoid. Consequently, based on a very low number of path elements, a trajectory may be computed, which satisfies the standards called for, which means that a computational expenditure is limited. The HC curve element may be defined by two concentric circles; the curve having the continuous radius running along an inner of the concentric circles, and the stretch of path having an increasing or decreasing radius connecting the inner to the outer of the concentric circles. The HC-curve element is, in particular, a combination of a clothoid and a curve having a constant radius. A selection of a number of possible curve elements is made. In this context, different ones of the possible curve elements may be selected in a single, possible trajectory. A minimum radius means that a curvature of the curve is equal to zero, since curvature=1/radius.

The different path elements may include a curve element and a straight-line element. Consequently, a high flexibility is achieved in the calculation of the possible trajectories. Detours in trajectories may be prevented.

During the selection of a trajectory from the possible trajectories, it is also advantageous if a length of the possible trajectories and/or a minimum number of changes in direction of the trajectories and/or a minimum change in curvature is the characteristic of the possible trajectories, on which the selection is based. Thus, in particular, the trajectory, which is the shortest of the possible trajectories, is selected from the possible trajectories. Alternatively, in particular, the trajectory, which includes the fewest changes in direction, is selected from the possible trajectories.

Alternatively, in particular, the trajectory, which has a minimum change of curvature, is selected from the possible trajectories. A trajectory having a minimum change of curvature is, in particular, one of the trajectories, in which, in total, the least change in a steering angle of the vehicle must occur, in order to follow the trajectory. A plurality of characteristics may also be weighted, in order to select the trajectory. Thus, the trajectory, which is particularly pleasant for a driver, is selected. If the trajectory, which is the shortest of the possible trajectories, is selected from the possible trajectories, then apart from the changes in direction, the result is a virtually optimal and, also, continuous-curvature connection between the starting position and the target position. Virtually optimal, because it is not analytically possible to prove this, but it is verifiable experimentally or by simulation.

In addition, it is advantageous if the path elements are interlinked in such a manner, that at a transition between two path elements, that is, at a node, a possible trajectory always has a continuous curvature characteristic, when, at the transition, the trajectory describes a motion of the vehicle in the same direction. Thus, the vehicle is prevented from being stopped only to allow a steering angle to be changed.

It is also advantageous for each of the path elements to have a starting point and an end point; the path elements being adapted for use within a possible trajectory by shifting the starting point and the end point relative to each other. Thus, a position of the two points with respect to each other is changed. Therefore, for example, a curve angle of a curve element may be defined by a relative position of the starting point with respect to the end point. A length of a straight-line element may also be defined by a relative position of the starting point with respect to the end point. Consequently, it is ensured that a low number of path elements is sufficient for generating the trajectory.

It is also advantageous for at least one intermediate target position to be defined in addition to the starting position and the target position. In this context, the intermediate target position is defined as is done by a sampling-based movement planner. An intermediate target position is a position, which lies on at least one of the possible trajectories. In particular, different intermediate target positions are defined for different, possible trajectories.

In addition, it is advantageous for the method to further include collision detection; an envelope curve of the vehicle being computed along the possible trajectories, and the possible trajectories, whose associated envelope curve indicates a collision with an object, being discarded. Consequently, the method may be used in the area of high-density parking in a particularly advantageous manner.

In the following, exemplary embodiments of the present invention are described in detail with reference to the accompanying drawings.

### BRIEF DESCRIPTION OF THE DRAWINGS

FIG. 1 shows a representation of a trajectory calculated according to the present invention.

FIG. 2 shows a representation of the possible curve elements.

FIG. 3 shows a representation of interlinked path elements, which are linked to form a possible trajectory.

FIG. 4 shows a representation of a first HC curve element.

FIG. 5 shows a representation of a second HC curve element.

FIG. 6 shows a representation of a vehicle having a device for calculating a trajectory of the vehicle.

FIG. 7 shows a representation of a trajectory computed with the aid of Reeds-Shepp steering.

FIG. 8 shows a representation of a trajectory computed with the aid of continuous-curvature steering.

### DETAILED DESCRIPTION

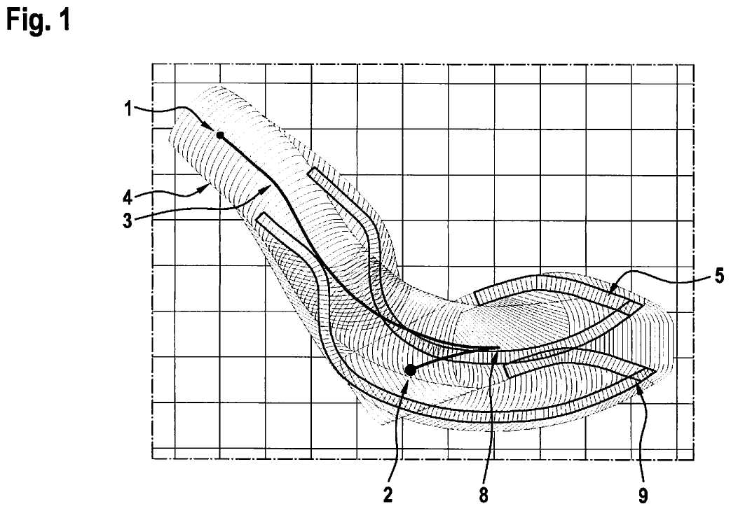

FIG. 1 shows a representation of a trajectory 3 calculated according to the present invention. Trajectory 3 connects a starting position 1 to a target position. Trajectory 3 is a trajectory calculated for a motion of a vehicle 100.

The method described in the following is also referred to as hybrid-curvature (HC) steering and simulates human behavior in the steering of a vehicle 100 in tight environments. In this context, trajectories 3 having continuous curvatures are calculated, while vehicle 100 moves in a direction. However, noncontinuous curvatures are allowed, if a change of direction takes place. This renders a high mobility of vehicle 100 possible in the case of short distances to be moved.

In the calculating of trajectory 3, starting position 1 and target position 2 of vehicle 100 are initially defined. Starting position 1 and target position 2 are determined, for example, by having them provided by an external driving assistance system. Thus, starting position 1 is, for example, a current position of vehicle 100, and target position 2 describes a position in a surrounding area of vehicle 100, to which vehicle is intended to be moved, for example, a parking space detected by a vehicle sensor system, or a generated configuration of the movement planner.

The calculations necessary for that are based on a mathematical vehicle model, by which, for example, a dimension of vehicle 100 and further vehicle characteristics are defined, for example, a maximum steering angle, the lane width, the wheelbase.

Trajectory 3, as is shown in FIG. 1, describes a motion of a point of vehicle 100. The point may be any arbitrary point, which moves along with a motion of vehicle 100. In FIG. 1, this point is, by way of example, a point, which is situated in the center of a rear axle of vehicle 100. In this context, a steering movement, which is to be executed by vehicle 100, in order to move the point along trajectory 3, may be derived directly from trajectory 3. Consequently, trajectory 3 could also be described by a tire track 5, which is represented illustratively in FIG. 1, as well. The tire track 5 illustrated in FIG. 1 is associated with trajectory 3, and the same motion of vehicle 100 is represented by the two.

After starting position 1 and target position 2 of vehicle 100 are defined, a number of possible trajectories 3 are generated. Each of the possible trajectories 3 connects starting position 1 and target position 2 of vehicle 100. Of course, vehicle 100 may typically be moved from starting position 1 to target position 2 in different ways. Possible trajectories 3 describe a selection of trajectories 3, which vehicle 100 may follow, in order to arrive at target position 2 from starting position 1.

In order to generate possible trajectories 3, different path elements are interlinked in different ways for interconnecting starting position 1 and target position 2 of vehicle 100. In this context, possible trajectories 3 are made up of a number of available, different path elements. The different path elements available include, for example, a curve element 11 and a straight-line element. Curve element 11 traces a curve. The straight-line element describes a section of path having a straight course. Each of path elements connects a starting point 30 to an end point 32.

In this context, curve element 11 is selected from one of the following, possible curve elements 20, 21, 22: an RS curve element 20, an HC curve element 21 and a CC curve element 22. Thus, curve element 10 indicates that the corresponding, possible trajectory 3 includes a curve. In this instance, the exact shape of the curve is still open and depends on whether RS curve element 20, HC curve element 21 or CC curve element 22 is selected.

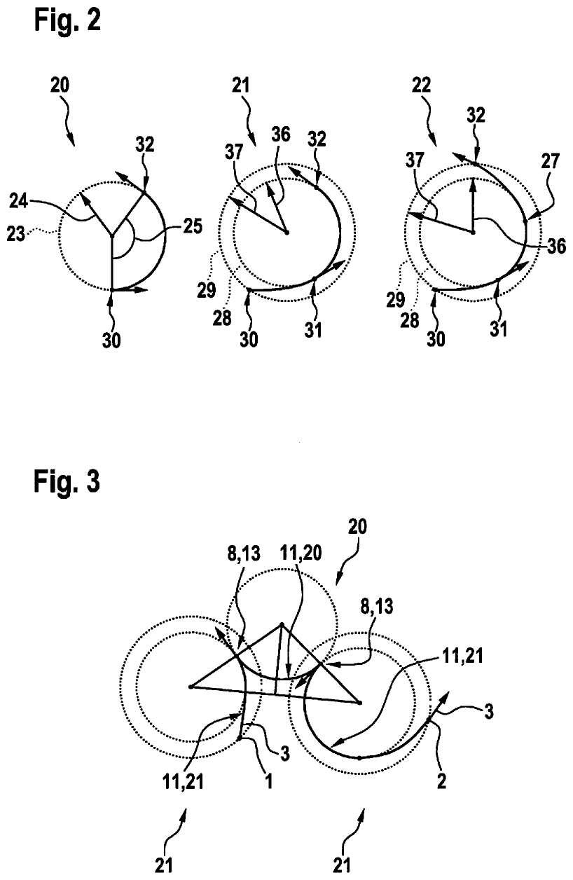

The possible curve elements 20, 21, 22 are shown in FIG. 2.

RS curve element 20 describes a curve having a constant curve radius; the RS curve element 20 having maximum curvature at its beginning and end. The constant curve radius corresponds to the maximum steering angle of vehicle 100. Thus, the path traced by RS curve element 20 lies on a first circle 23. Starting point 30 and end point 32 of RS curve element 20 are situated on first circle 23. Accordingly, RS curve element 20 defines a course of a possible trajectory 3 along a circular path, over a curve angle 25. In this context, first circle 23 has a minimum radius 24, which is equivalent to the constant curve radius and corresponds to the maximum steering angle of vehicle 100.

CC curve element 22 describes a combination of a curve having a constant curve radius and two curves having a radius increasing or decreasing over a stretch of path, with the characteristic of a minimum radius on the one side and an infinitely large radius on the other side; the curve having a constant curve radius being situated between the two curves having a nonconstant curve radius. CC curve element 22 has a curvature of zero at its beginning and end. In this context, the radius increases, in particular, linearly, over a stretch of path or decreases linearly over the stretch of path. In this instance, the curve having a constant curve radius lies on an inner circle 28. The constant curve radius corresponds to the maximum steering angle of vehicle 100. The section of CC curve element 22 having a constant curve radius begins at a first transition point 31 and ends at a second transition point 27. Starting point 30 and end point 32 of CC curve element 22 are situated on an outer circle 29. Inner circle 28 has an inner radius 36. Outer circle 29 has an outer radius 37. Outer radius 37 is greater than inner radius 36. Between starting point 30 and first transition point 31, the path traced by CC curve element 22 has a radius decreasing over a stretch of path. Between second transition point 27 and end point 32, the path traced by CC curve element 22 has a radius increasing over a stretch of path. In this context, the curve radius is selected in such a manner, that at first transition point 31 and at second transition point 27, it is equal to the constant curve radius of the curve having a constant radius, and is therefore equal to inner radius 36; and the outer radius is selected in such a manner, that the vehicle has a steering angle of 0/no curvature at starting position 30 and end position 32. HC curve element 21 describes a combination of a curve having a constant radius and a curve having a radius increasing or decreasing over a stretch of path. HC curve element 21 has a curvature of zero at its beginning or end. HC curve element 21 substantially corresponds to a CC curve element, but HC curve element 21 ends at second transition point 27. Thus, the curve having a constant curve radius lies on inner circle 28. The constant curve radius corresponds to the maximum steering angle of vehicle 100. The section of HC curve element 21 having a constant curve radius begins at a first transition point 31 and ends at end point 32. Thus, starting point 30 of HC curve element 21 lies on outer circle 29, where the vehicle has a 0° steering angle, and end point 32 of HC curve element 21 lies on inner circle 28. Inner circle 28 has inner radius 36. Outer circle 29 has outer radius 37. Outer radius 37 is greater than inner radius 36. Between starting point 30 and first transition point 31, the path traced by HC curve element 21 has a curve radius decreasing over a stretch of path. In this instance, the decreasing curve radius is selected in such a manner, that at first transition point 31, it is equal to the constant curve radius of the curve having a constant curve radius, and is therefore equal to inner radius 36. The decreasing radius has the characteristic that it is infinitely large at starting point 30, and that consequently, a curvature of HC curve element 21 is equal to zero at this point. In addition, the decreasing radius has the characteristic that it is at a minimum at first transition point 31, in this case, equal to inner radius 36.

All of possible curve elements 20, 21, 22 may be traversed in the two possible directions, that is, from end point 32 to starting point 30, as well.

Each of the path elements and, consequently, each of possible curve elements 20, 21, 22 has a continuous curvature characteristic over its full course, except if the path element defines a change of direction of vehicle 100 at the corresponding position. Mathematically, the continuous curvature characteristic means that the first derivative of the path elements in accordance with the displacement is continuous. With regard to CC curve element 22, this means that there is no sharp bend between the curve having a continuous radius and the curve having the radius that increases or decreases over the stretch of path.

In order to calculate possible trajectories 3, the path elements are interlinked in accordance with predefined combinations. Consequently, each of the possible trajectories is a predefined combination of the different path elements. In this context, each path element is also assigned a moving direction of vehicle 100. Accordingly, a change of direction of vehicle 100 may occur at a node of two adjoining path elements. Such a change of direction is also defined in the predefined combinations.

Thus, the predefined combination is made up of, in particular, the path elements and an indicator of a change of direction. Possible trajectories 3 are made up of different predefined combinations of path elements and the indicator of a change of direction. In this context, at a node 13 between two path elements, an end point 32 of a path element lies on a starting point 30 of a following path element. The combinations are predefined.

Thus, in the following, straight-line element 11 is represented by an “S,” curve element 11 is represented by a “C,” and the change of direction is represented by a “|.” An example of possible combinations could be formulated, for example, as follows: “C|C|C.” This means that starting position 1 and target position 2 are to be connected in the given order, by three curve elements 10 having changes of direction between them. The resulting, possible trajectory 3 is shown, by way of example, in FIG. 3. If the trajectory 3 illustrated there is followed from starting position 1 to target position 2, then the path elements are traversed in accordance with the above-described examples of possible combinations. In this instance, a path element first in the sequence is a curve element 11; HC curve element 21 having been selected as a curve element 11. A path element second in the sequence is, once again, a curve element 11; RS curve element 20 having been selected as a curve element 11. A path element third in the sequence is, once more, a curve element 11; HC curve element 21 having been selected as a curve element 11.

The example of a possible combination “C|C|C” is only one of a plurality of possible combinations. The plurality of possible combinations advantageously may include the following combinations: “C|C|C,” “C|CC,” “CC|C,” “CSC,” “CC|CC,” “C|CC|C,” “C|CSC,” “CSC|C,” “C|CSC|C,” “CCC,” “C|SC,” “CS|C,” “C|S|C.” It particularly may be provided for the plurality of possible combinations to include only the combinations mentioned above. A possible path of motion 3 is generated from each of the combinations.

During the generating of the number of possible trajectories, the path elements are interlinked at nodes 13 in such a manner, that a possible trajectory at a node 13 between two path elements may only have a discontinuous curvature characteristic, if the possible trajectory traces a change of direction of vehicle 100 at the transition. This is accomplished, for example, in that at nodes between two path elements, at which there is a change of direction, an HC curve element 21 is permitted to succeed another HC curve element 21, an HC curve element 21 is permitted to succeed an RS curve element 20, an RS curve element 20 is permitted to succeed an HC curve element 21, or an RS curve element 20 is permitted to succeed an RS curve element 20. In the case of a change in direction, a CC curve element need not be allowed, in order to keep trajectory 3 as short as possible. Consequently, trajectory 3 may have a discontinuous curvature characteristic at the node 13 between two path elements, at which there is a change of direction. This is the case, for example, at a reversal point 8, 9 of the trajectory 3 shown in FIG. 1, or at the two nodes 13 shown in FIG. 3.

In addition, it is ensured that at nodes 13 between two path elements, at which there is no change of direction, an RS curve element 20 is not allowed to be selected as a curve element 11 for any of the path elements. Instead, HC curve element 21 or CC curve element 22 must be selected for each curve element 10 bordering on such a node. In this context, a curve having a radius increasing or decreasing over a stretch of path must border on node 13.

In this case, the path elements are to be oriented in such a manner, that at a transition between the two path elements, that is, at node 13, the possible trajectory to be generated has a continuous curvature characteristic, if, at node 13, possible trajectory 3 describes a motion of vehicle 100 in an unvarying direction, which is the case when there is no change of direction at the node 13 in question. This is accomplished by suitably orienting the path elements, in particular, each possible curve element 20, 21, 22 selected. Thus, the path elements are interlinked in such a manner, that a possible trajectory always has a continuous curvature characteristic at a node 13 between two path elements, if the possible trajectory describes a motion of vehicle 100 in the same direction.

Since each combination determines a predefined number of path elements, but the position of starting position 1 relative to target position 2 is initially unknown, the path elements have a variable starting point 30 and end point 32. Thus, a curve angle traced by a possible curve element 20, 21, 22 may be changed by shifting starting point 30 with respect to end point 32 on, in each instance, the associated circular path.

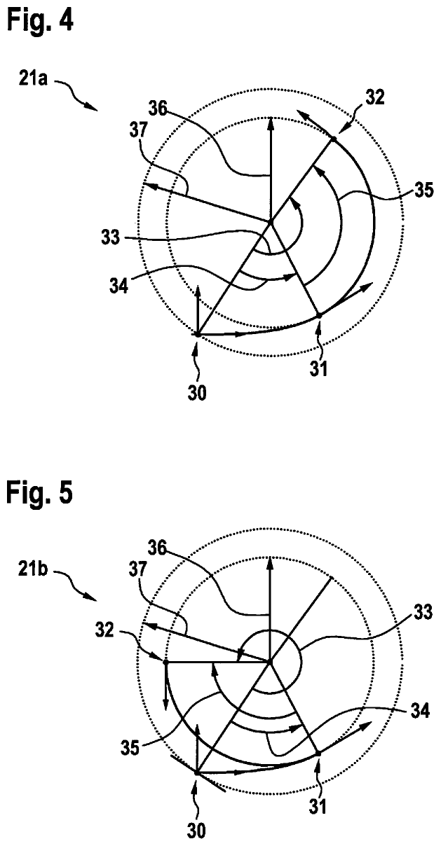

This is shown in FIGS. 4 and 5 for HC curve element 21. To that end, a first HC curve element 21a, which is a regular HC curve element 21b, is represented in FIG. 4. A second HC curve element 21, which is an irregular HC curve element 21, is represented in FIG. 5.

It is apparent that starting points 30 for first HC curve element 21a and second HC curve element 21b are selected to be identical. However, end points 32 for first HC curve element 21a and second HC curve element 21b are selected to be different. Thus, first HC curve element 21a and second HC curve element 21b trace different curve angles 33. In this context, curve angle 33 is made up of a first partial angle 34 and a second partial angle 35. In this instance, first partial angle 24 is traced by the region of the HC curve element 21 having the radius that decreases linearly over the stretch of path. In this context, second partial angle 35 is traced by the region of HC curve element 21 having the constant curve radius.

In this case, at first transition point 31, second curve element 21b has a change of direction including a continuous curvature transition.

It is apparent that second HC curve element 21b would also connect the starting point 30 shown in FIG. 5 to end point 32, if the portion having a constant radius of movement were guided in the direction shown in FIG. 4. However, this would result in a different direction of movement of the vehicle at end point 32.

It is further apparent that end point 32 may fall on first transition point 31 of HC curve element 21. In this case, the region having the constant curve radius of HC curve element 21 has a length of zero. This is the case, for example, with the trajectory 3 shown in FIG. 3, for the HC curve element 21 beginning at starting position 1. Alternatively, in a calculation of trajectory 3 shown in FIG. 3, the region having the constant curve radius may have turned out to be very short, so that it is not recognizable in the view.

A plurality of possible trajectories are generated in a corresponding manner; each of the possible trajectories corresponding to a separate, predetermined combination of path elements. Consequently, the number of possible trajectories is generated such, that the different path elements are combined with each other in different ways. In this context, each of the possible trajectories is a predefined combination of the different path elements.

A trajectory 3 is intended to be selected from the possible trajectories 3. This selected trajectory 3 is provided for a motion of vehicle 100. To that end, trajectory 3 is selected from possible trajectories 3 on the basis of a characteristic of possible trajectories 3.

In order to prevent selected trajectory 3 from resulting in a collision of vehicle 100 with an obstacle, collision detection is initially carried out. To that end, a path element (shortest path) is selected. It is then checked if the path element would result in a collision at the corresponding position in a possible trajectory 3. If a collision is present, then the solution is discarded, and, for example, a new configuration is sampled as a function of the planning algorithm. Consequently, the points in the surroundings of the vehicle, which are intersected by vehicle 100 during its motion along the specific, possible trajectory 3, are calculated. If it is detected that an object is on one of the points, which are intersected during the motion of vehicle 100 along the specific, possible trajectory 3, then the corresponding, possible trajectory 3 is discarded, since its associated envelope curve 4 indicates a collision with an object. This is then the case, if a point, on which the object is situated, lies inside of the envelope curve.

From the remaining, possible trajectories 3, the trajectory 3, which has the shortest length of all of the remaining, possible trajectories 3, which has the lowest number of changes in direction of all remaining, possible trajectories 3, or which has the lowest change in curvature, is selected. In this context, the possible trajectories 3 possessing the shortest length have the lowest probability of a collision. However, if a collision is present, then this solution is discarded, and, for example, the next shortest of possible trajectories 3 is selected.

In this instance, the selection may also be made based on a combination of the length and the number of changes in direction. Thus, the selection of trajectory 3 from possible trajectories 3 is based on a length of possible trajectories 3 and/or on a number of changes in direction of trajectories 3.

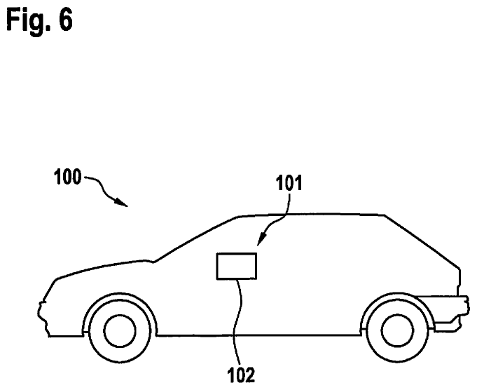

FIG. 6 shows a representation of the vehicle 100 having a device 101 for calculating trajectory 3 of vehicle 100. To that end, a processing unit 102, which is configured to execute the method described above, is situated in vehicle 100.

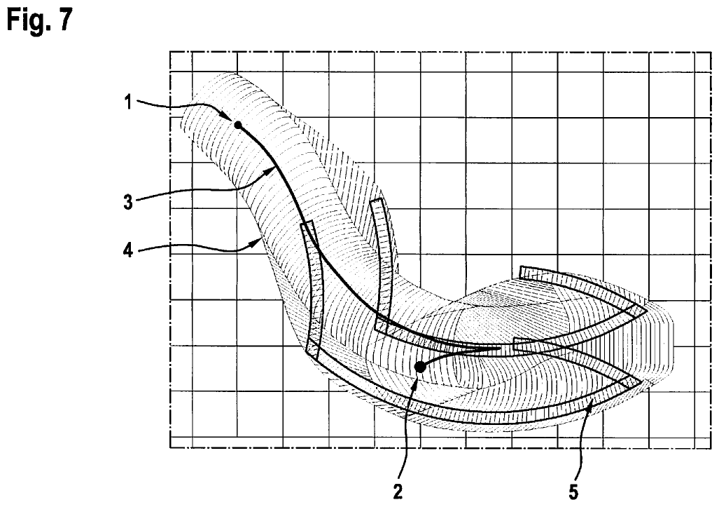

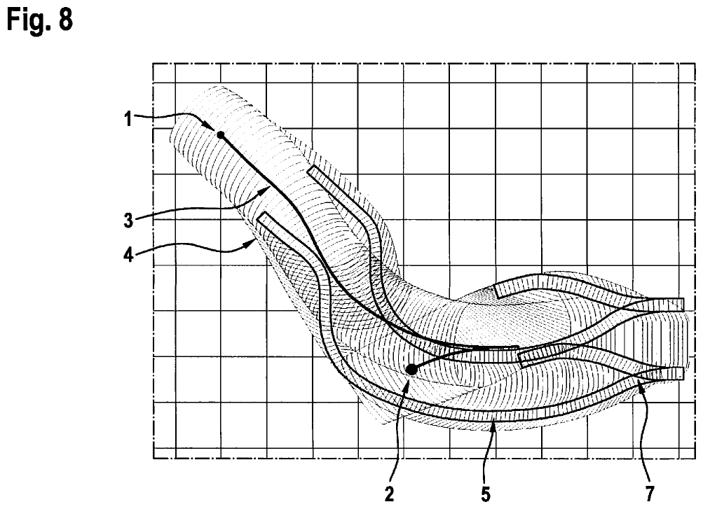

Apart from the written description above, reference is explicitly made to the content of FIGS. 1 through 8.

1-10. (canceled)

11. A method for calculating a trajectory of a vehicle, the method comprising:
determining a starting position and a target position of the vehicle;
generating a number of possible trajectories, which precisely interconnect the starting position and the target position;
interlinking, for each possible trajectory, different path elements in different ways, to interconnect the starting position and the target position of the vehicle, wherein the path elements being interlinked so that a possible trajectory only has a discontinuous curvature characteristic at a node between two path elements, if the possible trajectory traces a change of direction at the node; and
selecting a trajectory from the possible trajectories based on a characteristic of the possible trajectories.

12. The method of claim 11, wherein the number of possible trajectories is generated by combining the different path elements with each other in different ways.

13. The method of claim 12, wherein each of the possible trajectories is a predefined combination of the different path elements.

14. The method of claim 11, wherein the different path elements include a curve element, and during the generation of the number of possible trajectories, the curve element is selected from one of the following:
(i) an RS curve element, which describes a curve having a constant curve radius;
(ii) an HC curve element, which is a combination of a curve having a constant radius and a curve having a radius increasing or decreasing over a stretch of path, with the characteristic of a minimum radius on the one side and an infinitely large radius on the other side; and
(iii) a CC curve element, which is a combination of a curve having a constant radius and, in front of it or in back of it, in each instance, a curve having a radius increasing or decreasing over a stretch of path.

15. The method of claim 11, wherein the different path elements include a curve element and a straight-line element.

16. The method of claim 11, wherein in the selection of a trajectory from the possible trajectories, a length of the possible trajectories and/or a minimum number of changes in direction of the trajectories and/or a minimum change in curvature is the characteristic of the possible trajectories, on which the selection is based.

17. The method of claim 11, wherein the path elements are interlinked in such a manner, that a possible trajectory always has a continuous curvature characteristic at a node between two path elements, if the possible trajectory describes a motion of the vehicle at the node, in an unchanging direction.

18. The method of claim 11, wherein each of the path elements has a starting point and an end point; the path elements being adapted for use within a possible trajectory by shifting the starting point and the end point relative to each other.

19. The method of claim 11, wherein apart from the starting position and the target position of the vehicle, at least one intermediate target position is defined.

20. A device for calculating a trajectory of a vehicle, comprising:
a processing unit configured to perform the following:
defining a starting position and a target position of the vehicle;
generating a number of possible trajectories, which precisely interconnect the starting position and the target position;
interlinking, for each possible trajectory, different path elements in different ways, to interconnect the starting position and the target position of the vehicle, wherein the path elements are interlinked so that a possible trajectory only has a discontinuous curvature characteristic at a node between two path elements, if the possible trajectory traces a change of direction at the node; and
selecting a trajectory from the possible trajectories based on a characteristic of the possible trajectories.
